(19) United States
(12) Patent Application Publication
(10) Pub. No.: US 2010/0109190 A1
(43) Pub. Date: May 6, 2010

(54) PROCESS FOR PRODUCING THERMOPLASTIC RESIN MOLDING

(76) Inventor: Satoshi Hanada, Tokushima-shi Tokushima (JP)

Correspondence Address: FITCH, EVEN, TABIN & FLANNERY, P. O. BOX 18415, WASHINGTON, DC, 20036, US

(21) Appl. No.: 12/524,493

(22) PCT Filed: Jan. 29, 2008
(86) PCT No.: PCT/JP2008/051703

§ 371 Date: Nov. 17, 2009

(30) Foreign Application Priority Data
Jan. 30, 2007 (JP) 2007-018994

(51) Int. Cl. B29C 45/14

(52) U.S. Cl. 264/250

(57) ABSTRACT

A method for producing a thermoplastic resin molded article having a thermoplastic resin foam substrate and a functional member joined by welding to the foam substrate is provided.

The occurrence of a dimple on the surface of the molded article is prevented by supplying a molten thermoplastic resin into a cavity for forming the functional member and then, before the occurrence of shrinkage of the resin due to the solidification of the resin, reducing force with which the foam substrate is compressed, thereby equalizing the shrinkage of the surface of the functional member.

### TECHNICAL FIELD

The present invention relates to a method for producing a thermoplastic resin molded article comprising a foam substrate made of a first thermoplastic resin and a functional member made of a second thermoplastic resin which has been joined by welding to the foam substrate so as to project from the foam substrate.

### BACKGROUND ART

Expansion molded articles produced by molding thermoplastic resin foam sheets are used for various applications, such as automotive components and building materials, because they are excellent in lightweight property, recyclability, thermal insulating properties, etc. Thermoplastic resin molded articles in which nonexpanded functional members, such as ribs, bosses and hooks, made of a thermoplastic resin have been joined by welding to such expansion molded articles can also be used as automotive interior components, etc. As a method for producing the aforementioned thermoplastic resin molded article, a method including the following steps (1) to (4) is known (see, for example, JP 2001-121561 A):

(1) a step of supplying a foam sheet made of a thermoplastic resin to between a pair of molds, at least one of which has a recess with a shape of a functional member;

(2) a step of closing the molds, thereby shaping the thermoplastic resin foam sheet and simultaneously closing the opening of the recess with the thermoplastic resin foam sheet;

(3) a step of supplying a thermoplastic resin in a molten state into the recess through a resin passage provided in a mold so as to lead to the recess, thereby joining the thermoplastic resin and the thermoplastic resin foam sheet together by welding to form the aforementioned thermoplastic resin molded article while maintaining the molds closed and the opening of the recess closed with the thermoplastic resin foam sheet;

(4) a step of cooling the thermoplastic resin molded article formed in the step (3) and taking it out of the molds.

### DISCLOSURE OF THE INVENTION

As to thermoplastic resin molded articles produced by the method described above, a depression (3) called a “dimple” may be formed on a surface of a thermoplastic resin molded article (2), the surface corresponding to a portion at which a functional member (1) like that shown in FIG. 1 has been formed.

The present invention provides a method for producing a thermoplastic resin molded article comprising a foam substrate made of a first thermoplastic resin and a functional member made of a second thermoplastic resin which has been joined by welding to the foam substrate so as to project from the surface of the foam substrate, by which method a molded article with good appearance having no dimples can be produced.

That is, the present invention provides a method for producing a thermoplastic resin molded article comprising a foam substrate made of a first thermoplastic resin and a functional member made of a second thermoplastic resin which has been joined by welding to the foam substrate so as to project from a surface of the foam substrate, the method comprising the following steps (1) through (6) that are carried out by the use of a molding machine comprising a first mold that has a first molding surface having a recess defining a cavity for forming the functional member therein and that has a resin passage leading to the cavity and a second mold that has a second molding surface and is arranged with the second molding surface facing the first molding surface:

(1) a step of supplying a foam substrate made of the first thermoplastic resin to between the first mold and the second mold;

(2) a step of closing the first mold and the second mold until a force at which the first mold and the second mold compress the foam substrate made of the first thermoplastic resin reaches a predetermined force P1;

(3) a step of supplying the second thermoplastic resin in a molten state into the cavity through the resin passage until the cavity is filled up therewith while maintaining the pressure by which the foam substrate is compressed at P1;

(4) a step of reducing the force by which the foam substrate is compressed from P1 to a predetermined force P2 after stopping supplying the second thermoplastic resin in the molten state;

(5) a step of cooling the second thermoplastic resin to solidify it while compressing the foam substrate at the force P2 by the first and second molds, thereby forming the functional member in the recess and simultaneously forming a thermoplastic resin molded article comprising the functional member and the foam substrate;

(6) a step of opening the molds and taking out the thermoplastic resin molded article.

### BRIEF DESCRIPTION OF THE DRAWINGS

FIG. 1 is a sectional view showing a dimple formed on a molded article's surface corresponding to the portion at which a functional member has been formed.

FIG. 2 is a sectional view of the first mold.

FIG. 3 is another sectional view of the first mold.

FIG. 4 (1) to FIG. 4 (4) are diagrams showing the outline of the method of the present invention.

FIG. 5 is a plan view of a thermoplastic resin molded article having a rib.

FIG. 6 is a sectional view of the thermoplastic resin molded article of FIG. 5 taken along line (a).

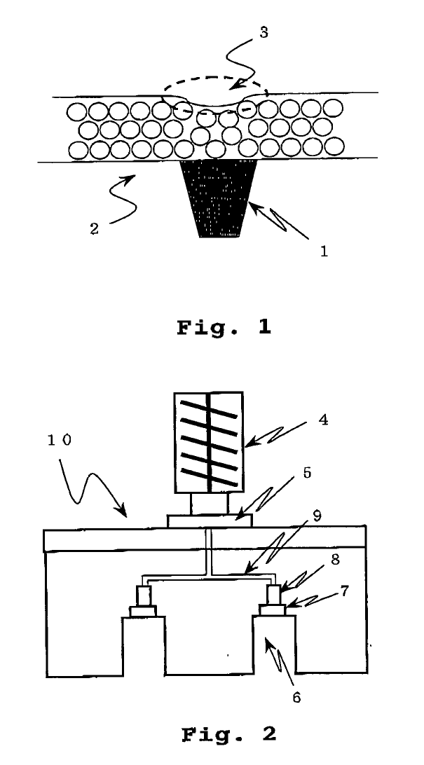

The reference numbers in the drawings respectively have meanings as follows: 1: functional member, 2: thermoplastic resin molded article, 3: dimple on the surface of a molded article, 4: screw-type extruder, 5: nozzle, 6: cavity, 7: gate, 8: sprue, 9: runner, 10: first mold, 11: width of an opening, 12: width of a bottom, 13: height, 14: foam substrate, 15: clamping frame, 16: second mold, 17: rib (functional member) 18: thermoplastic resin molded article, and 19: length of a rib.

### MODE FOR CARRYING OUT THE INVENTION

The present invention provides a method for producing a thermoplastic resin molded article comprising a foam substrate made of a first thermoplastic resin and a functional member made of a second thermoplastic resin which has been joined by welding to the foam substrate so as to project from a surface of the foam substrate. The method is carried out by the use of a molding machine comprising a first mold that has a first molding surface having a recess defining a cavity for forming the functional member therein and that has a resin passage leading to the cavity and a second mold that has a second molding surface and is arranged with the second molding surface facing the first molding surface. In the following description, the first mold and the second mold are sometimes collectively called a pair of molds.

The first and second molds may be various combinations such as a combination of a male mold and a female mold, a combination of two female molds, and a combination of two flat molds. The position where the recess is provided on the molding surface of the first mold, i.e., the first molding surface, and the shape of the recess are not particularly restricted. A mold that has been provided with a recess according to the position and the shape of a functional member to be joined onto a foam substrate can be used. Molded articles to be produced by the method of the present invention may have either one functional member or two or more functional members. When a molded article having one functional member is produced, a first mold having only one cavity for forming the functional member is used. When a molded article having two or more functional members is produced, a first mold having cavities as many as the number of the functional members to be formed is used. While the first and second molds have no particular limitations on their material, they are normally made of metal from the viewpoints of dimensional stability and durability. From the cost and weight points of view, the molds are preferably made of aluminum or stainless. Both the molds are preferably structured so that the temperature thereof can be controlled with a heater or heat medium. For preventing the foam substrate from deforming, the molding surfaces of the molds are preferably adjusted within a range of from 20 to 80° C., and more preferably from 30 to 60° C. during the production of a thermoplastic resin molded article. Molds through which vacuum suction or supply of compressed air can be applied may be used.

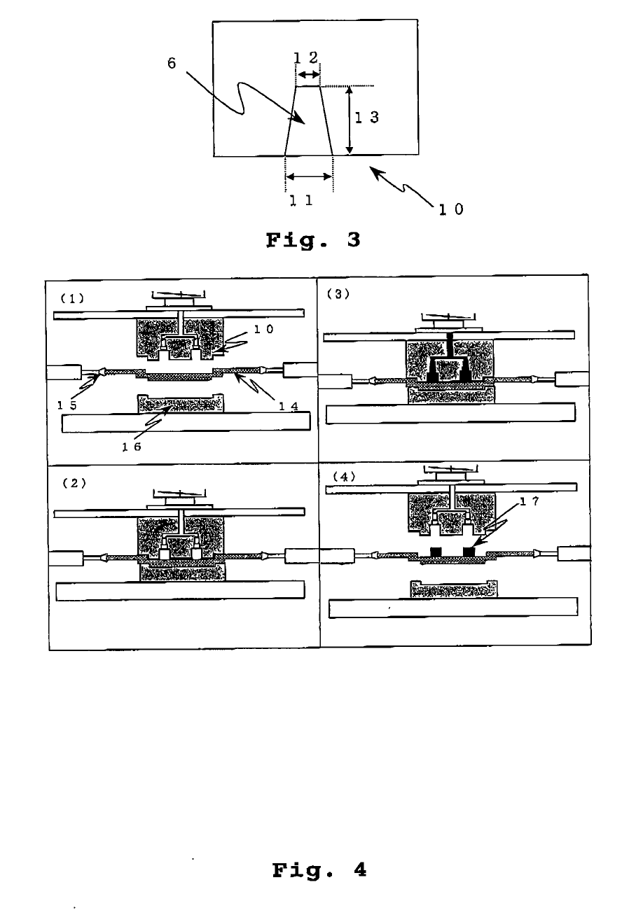

As shown in FIG. 2, the first mold (10) has a resin passage through which a molten thermoplastic resin is introduced into a cavity (6) defined by a recess on the first molding surface and the resin passage is opened at its one end in the recess. In this embodiment, the other end of the passage is connected to a nozzle (5) located at the tip of a screw type extruder (4) The portion (7) where the resin passage is opened in the recess is called “gate” and the gate (7) is located at the bottom of the recess. In the case of a resin passage having a common structure, a molten thermoplastic resin is supplied into the cavity (6) through the gate via a conduit (9) that is called “runner” or a cylindrical cavity (8) that is called “sprue”. When the resin passage is long, it is desirable for the resin passage to be equipped with heating means such as a heater in order to prevent the molten thermoplastic resin from cooling to solidify. One recess may have either one gate or a plurality of gates. When the functional member to be formed in the cavity (6) is a rib, a cross section of the recess defining the cavity (6), which cross section is perpendicular to the longitudinal direction of the recess, is usually in the shape depicted in FIG. 3. The recess defining the cavity (6) is characterized by the opening width (11), the bottom width (12), the height (13), and so on. Because of excellence in releasability from a mold exhibited in molding, the opening width (11) is made approximately 0.1 to 0.5 mm greater than the bottom width (12).

In the present invention, a foam substrate made of a thermoplastic resin is used. Examples of the thermoplastic resin for forming the foam substrate include olefin-based resin such as homopolymers of olefins having from 2 to 6 carbon atoms, e.g. ethylene, propylene, butene, pentene and hexene and olefin copolymer produced by copolymerizing of two or more kinds of monomers selected from olefins having from 2 to 10 carbon atoms, ethylene-vinyl ester copolymer, ethylene-(meth)acrylic acid copolymer, ethylene-(meth) acrylic ester copolymer, ester resin, amide resin, styrenic resin, acrylic resin, acrylonitrile-based resin and ionomer resin. These resins may be used either solely or in a combination of two or more resins. Olefin-based resins are preferably used from the viewpoints of moldability, oil resistance and cost. Propylene-based resins are particularly preferably used from the viewpoint of rigidity and heat resistance of resulting molded articles.

Examples of the propylene-based resins include propylene homopolymers and propylene-based copolymers containing at least 50 mol % of propylene units. The copolymers may be block copolymers, random copolymers and graft copolymers. Examples of the propylene-based copolymers to be suitably employed include copolymers of propylene with ethylene or an α-olefin having 4 to 10 carbon atoms Examples of the α-olefin having 4 to 10 carbon atoms include 1-butene, 4-methylpentene-1, 1-hexene and 1-octane. The content of the monomer units except propylene in the propylene-based copolymer is preferably up to 15 mol % for ethylene and up to 30 mol % for α-olefins having 4 to 10 carbon atoms. The propylene-based resin may be composed of either a single kind of polymer or a mixture of two or more kinds of polymers.

When a long-chain-branching propylene-based resin or a propylene-based resin having a weight average molecular weight of 1×10⁵ or more is used in an amount of 50% by weight or more of the thermoplastic resin forming a foamed layer, it is possible to produce a propylene-based resin foamed substrate containing finer cells. Among such propylene-based resins, non-crosslinked propylene-based resin is suitably used because it will hardly cause gelation during a recycling process.

The foaming agent for use in the present invention may be either a chemical foaming agent or a physical foaming agent. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents which form carbon dioxide gas through their decomposition (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed substrates will produce less deformation resulting from secondary foaming during the heating in a vacuum forming process and also because those agents are substances inert under high temperature conditions and inert to fire. While the amount of the foaming agent used is properly determined on the basis of the kinds of the foaming agent and resin used so that a desired expansion ratio is achieved, 0.5 to 20 parts by weight of foaming agent is usually used for 100 parts by weight of the thermoplastic resin.

While the method for producing the foam substrate is not particularly restricted, a sheet obtained by extrusion forming using a flat die (T die) or a circular die is desirable. A method is used particularly preferably in which a molten resin is caused to be extruded while being allowed to foam, followed by being stretched and cooled over a mandrel or the like. When producing a foam sheet by extrusion forming, it is also permissible to extrude a molten resin through a die, cool it to solidify, and then perform stretching. While the foam sheet may have either a single layer or a plurality of layers, a multilayer foam sheet having non-foam layers as exterior layers is preferable from the viewpoints of prevention of breakage at the time of forming the sheet. While the resins which have been provided as examples of the resin forming the foam layer can be used as the resin forming the non-foam layer(s), the resin forming the non-foam layer(s) is preferably a resin of a type the same as that of the resin forming the foam layer. For example, when the foam layer is made of a propylene-based resin, it is desirable that the non-foam layer(s) be also made of a propylene-based resin. While the thermoplastic resin foam sheet to be used is not particularly restricted, a foam sheet having an expansion ratio of from 2 to 10 and a thickness of approximately from 1 to 10 mm is usually used.

The foam substrate used in the present invention may have a skin material laminated on a surface thereof. Examples of the skin material include materials that have functions of decoration, improvement in touch feeling, reinforcement or protection. Specific examples include woven fabric, nonwoven fabric, knit fabric, sheet, film, foam and mesh. Examples of materials for forming such skin materials include thermoplastic resins, such as olefin-based resins, vinyl chloride-based resins and styrene-based resins, thermosetting resins, such as urethane-based resins, rubbers and thermoplastic elastomers, such as cis-1,4-polybutadiene and ethylene-propylene copolymers, cellulosic fibers, such as cotton, hemp and bamboo. Such skin materials may have been applied with uneven patterns such as grain pattern, print or dyeing and they may be of either a single layer structure or a multiple layer structure. A skin material in which a cushion layer has been formed in order to add soft feeling can also be used. Lamination of a foam substrate and a skin layer can be performed by dry lamination, sandwich lamination, hot roll lamination, hot air lamination, or the like.

The foam substrate to be used in the present invention may contain additives. Examples of such additives include fillers, antioxidants, light stabilizers, UV absorbers, plasticizers, antistatic agents, colorants, releasing agents, fluidity-imparting agents and lubricants. Specific examples of the filler include inorganic fibers, such as glass fiber and carbon fiber, and inorganic particles, such as talc, clay, silica, titanium oxide, calcium carbonate and magnesium sulfate.

In the present invention, while the thermoplastic resin to be used as the material forming the functional member is not particularly restricted, a resin which exerts good weldability to the thermoplastic resin forming the foam substrate is chosen. A thermoplastic resin which is the same as or similar to the thermoplastic resin forming the foam substrate is preferred from the viewpoint of welding strength to the foam substrate. The thermoplastic resin for the functional member may also include various kinds of additives. Examples of such additives include fillers, antioxidants, light stabilizers, UV absorbers, plasticizers, antistatic agents, colorants, releasing agents, fluidity-imparting agents and lubricants.

The method of the present invention is performed, as described above, by the use of a molding machine having a first mold that has a first molding surface having a recess defining a cavity for forming a functional member therein and has a resin passage leading to the cavity at a gate opening at the bottom of the recess and a second mold that has a second molding surface and arranged with the second molding surface facing the first molding surface.

The method of the present invention is described with reference to FIG. 4(1) to FIG. 4(4). Step (1) is a step of supplying a foam substrate (14) made of a first thermoplastic resin to between a first mold (10) and a second mold (16) as illustrated in FIG. 4(1). In this step, the foam substrate is usually fixed with a clamping frame (15).

The foam substrate may have been shaped preliminarily into a desired shape before its supply to between the molds. In the preliminary shaping of foam substrate, the first mold and the second mold may be used. A mold that has a molding surface of the same configuration as that of the molding surface of the first mold except for having no recess may be used instead of the first mold. It is permissible to heat the foam substrate to soften it before its supply to between the molds. In this case, the step (2), which is described later, is preferably performed before the foam substrate loses its softened state suitable for shaping. The method for heating the foam substrate is not particularly limited and it may be a method of heating the foam substrate with a heater or hot air. The heating is performed desirably so that the surface temperature will become the melting temperature (for crystalline resins) or softening temperature (for noncrystalline resins) of the thermoplastic resin forming the foam substrate or higher. In the case of, for example, a foam substrate made of a propylene-based resin, it is desirable to heat so that the surface temperature will become about 180° C. to about 220° C. The temperature of the surface of the foam substrate can be measured by bringing a thermocouple into contact with the surface.

Step (2) is a step of closing the first mold and the second mold until a force at which the first mold and the second mold compress the foam substrate made of the first thermoplastic resin reaches a predetermined force P1. The force P1 is desirably within the range of 0.1 to 0.5 MPa. FIG. 4(2) shows a state where mold closure has been completed.

Step (3) is a step of supplying the second thermoplastic resin in a molten state into the cavity through the resin passage until the cavity is filled up therewith while maintaining the pressure by which the foam substrate is compressed at P1. FIG. 4(3) shows a state where supply of a thermoplastic resin has been completed.

In the case of using a foam substrate that has been softened by being heated, it is desirable that the surface temperature of the foam substrate at the time of supplying a molten thermoplastic resin be as low as allowable. Usually, temperatures not higher than the softening temperature of the thermoplastic resin forming the foam substrate are allowed. For example, for a foam substrate made of a propylene-based resin, the surface temperature is desirably within the range of from 100 to 50° C.

Step (4) is a step of reducing the force by which the foam substrate is compressed from P1 to a predetermined force P2 after stopping supplying the second thermoplastic resin in the molten state. It is desirable to reduce the compression force P1 to a predetermined force P2 within 60 seconds, more desirably within 30 seconds, and even more desirably within 10 seconds after stopping the supply of the molten second thermoplastic resin. The force P2 is desirably within the range of 0.01 to 0.09 MPa. The compression force can be reduced by slightly increasing the clearance between the molding surfaces by moving the first mold and the second mold relatively away from each other by a small distance.

Step (5) is a step of cooling the second thermoplastic resin to solidify it while compressing the foam substrate at the force P2 by the first and second molds, thereby forming the functional member in the cavity and simultaneously forming a thermoplastic resin molded article comprising the functional member and the foam substrate.

It is desirable that P1 be within the range of from 0.1 to 0.5 MPa and P2 be within the range of from 0.03. to 0.09 MPa. In addition, it is desirable that P1 and P2 satisfy a relationship 2≦P1/P2≦30.

In general injection molding, it is known that after supplying a molten thermoplastic resin a pressure is applied to the injected resin or molds in order to prevent the occurrence of a dimple in an injection molded article. However, when a molten thermoplastic resin is joined by welding to only a part of a foam substrate as in the present invention, if the foam substrate is continued to be compressed with a strong force also after the molten thermoplastic resin is supplied, the surface of a functional member in contact with a recess of a mold is cooled rapidly to solidify earlier and the interface between the functional member and the foam substrate is cooled slowly, so that the functional member shrinks greatly at the interface. Therefore, the foam substrate is pulled by its portion joined to the functional member due to the shrinkage and, as a result, a dimple has tended to be formed on the surface of the molded article opposite to the portion joined to the functional member. In the present invention, therefore, the formation of a dimple is prevented by equalizing the shrinkage of the surface of the functional member by reducing, before the shrinkage occurs, the pressure with which the foam substrate is compressed.

When a sheet-shaped foam substrate is used as the foam substrate, it is desirable to compress the foam substrate with a predetermined force P0 before compressing the foam substrate at a predetermined force P1 in step (2), thereby forming the foam substrate into a desired shape. The predetermined force PO is a force weaker than the force P1. By forming a foam substrate with a weak force P1 into a predetermined shape first and then supplying a molten thermoplastic resin while compressing the foam substrate at a strong force P2, it is possible to inhibit the foam substrate from deforming and prevent the molten thermoplastic resin from flowing out of the recess of a molding surface to the surface of the foam substrate and, as a result, a thermoplastic resin molded article with good external appearance can be obtained. The force P0 is desirably within the range of 0.01 to 0.09 MPa. In addition, 2≦P1/P0≦30 is desirably satisfied.

In each of the steps of the method of the present invention for producing a thermoplastic resin molded article, vacuum suction or supply of compressed air may be performed through a molding surface of a mold. In the method of the present invention for producing a thermoplastic resin molded article, it is permissible to perform vacuum suction through a molding surface of a mold, or perform vacuum suction through a molding surface of a mold, or perform supply of compressed air through the molding surface of the second mold. By the execution of such vacuum suction or supply of compressed air, it is possible to attach the pressure-resistant sheet or the foam substrate closely to a molding surface and it thereby is possible to prevent detachment or unintentional displacement of the pressure-resistant sheet or prevent leak of the molten resin to be fed. When vacuum suction is executed, it is desirable to conduct the suction so that the degree of vacuum in the gap between a molding surface and the foam sheet may fall within the range of from −0.05 to −0.1 MPa. The degree of vacuum is the pressure in the gap between the molding surface and the foam substrate expressed on the basis of the atmospheric pressure. That is, “the degree of vacuum is −0.05 MPa” means that the difference between the atmospheric pressure and the pressure in the sucked gap between the foam substrate and the molding surface is 0.05 MPa. The degree of vacuum is detected within a vacuum suction passage provided in a mold. When compressed gas is supply through the molding surface of the second mold, the compressed gas is desirably supplied so that the pressure in the gap between the molding surface and the foam substrate may fall within the range of from 0.05 MPa to 0.7 MPa.

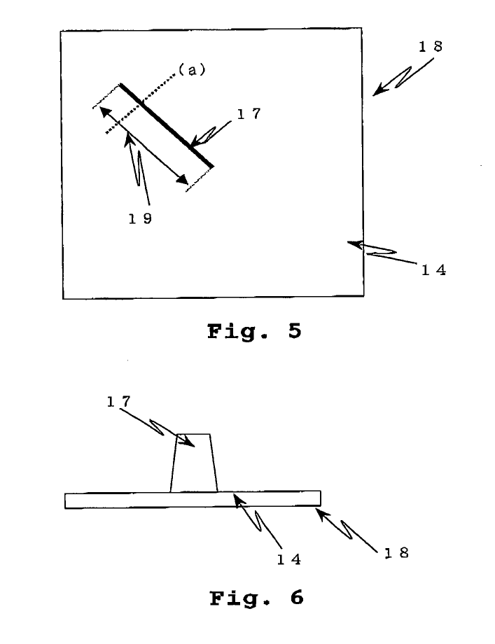

Step (6) is a step of opening the molds and taking out a thermoplastic resin molded article as illustrated in FIG. 4(4). One example of thermoplastic resin molded articles to be obtained by the method of the present invention is illustrated in FIG. 5 and FIG. 6. The thermoplastic resin molded article (18) to be obtained is a thermoplastic resin molded article comprising a foam substrate (14) made of a first thermoplastic resin and a functional member (17) made of a second thermoplastic resin which has been joined by welding to the foam substrate so as to project from the foam substrate. Specific examples of the functional member in the present invention include a rib, which has a function of reinforcing a thermoplastic resin molded article, or components like a boss, a clip or a hook that have a function of attaching a thermoplastic resin molded article to another object. In the molded article depicted in FIG. 5, the functional member (17) is a rib and reference sign 19 expresses the length of the rib (17). As to the thermoplastic resin molded article obtained in the present invention, a surface of the foam substrate opposite to the surface on which a functional member has been joined by welding to the foam substrate, that is, the surface to be shaped with the second mold is usually a designed surface.

The thermoplastic resin molded articles obtained by the present invention can be used for packaging materials, such as food containers, automobile interior components, building materials and household electric appliances. Examples of automobile interior components include door trims, ceiling materials and trunk side trims. For example, when a thermoplastic resin molded article having a rib joined by welding as a functional member is used as an automobile interior component, cars having the interior component becomes high in strength. When using a thermoplastic resin molded article having a boss or a hook joined by welding as a functional member, it can be connected to other automobile constituent components easily.

### EXAMPLES

The present invention is described below with reference to examples, but the invention is not limited to the examples.

The molds used in an example and a comparative example are as follows.

First mold: a mold having, in its molding surface, a recess that defines a cavity for forming a rib of 3 mm in thickness, 5 mm in height and 150 mm in length. A resin passage composed of a sprue, a runner and so on provided in the mold was connected and opened to the recess via a gate 8 mm in diameter.

Second mold: a mold having a flat molding surface and being capable of vacuum sucking.

### (1) Preparation of A Foam Substrate

A foam substrate was produced by using a polypropylene foam non-crosslinked sheet (commercial name: SUMICELLER, produced by Sumika Plastech Co., Ltd.) having an expansion ratio of 3 and a thickness of 3 mm and a laminate sheet composed of an olefin-based thermoplastic elastomer sheet having a thickness of 0.6 mm and a polypropylene crosslinked foam sheet having an expansion ratio of 10 and a thickness of 2.5 mm (commercial name: VINYLER, produced by Kyowa Leather Cloth Co., Ltd.).

Hot air of a temperature of 250° C. and a flow rate of 15 m/sec was blown from a hot air source to a surface of the polypropylene non-crosslinked foam sheet, thereby melting the surface. The melted polypropylene non-crosslinked foam sheet was superposed on the laminate sheet so as to face the surface of the polyorpylene crosslinked foam sheet of the laminate sheet. The sheets were supplied at a line speed of 2.5 m/min to between a pair of rolls having a roll-roll distance of 3 mm and a nipping pressure of 0.05 MPa. Thus, a foam substrate having a thickness of 6.1 mm was produced.

### Example 1

The foam substrate was fixed to a clamping frame of a vacuum forming machine (VAIM0301, manufactured by Sato Tekko Co., Ltd.) and was heated with a near-infrared heater so that the polypropylene non-crosslinked foam sheet surface of the foam substrate would come to have a temperature of 200° C. Thus, the foam substrate was softened. The softened foam substrate had a thickness of 6.3 mm. While the foam substrate was fixed to the clamping frame, it was supplied to between a first mold and a second mold so that the polypropylene non-crosslinked foam sheet side might be located on the first mold side. The temperature of the second mold was adjusted at 50° C.

The first mold and the second mold were closed until the compression force P0 to the foam substrate would become 0.03 MPa, and vacuum suction at −0.09 MPa was performed through the molding surface of the second mold, thereby shaping the foam substrate. After cooling the foam substrate until the temperature of the surface of the polypropylene non-crosslinked foam sheet reached 80° C., the first mold and the second mold were closed until the compression force P1 to the foam substrate would become 0.2 MPa. A molten propylene-based resin (polypropylene produced by Sumitomo Chemical Co., Ltd., commercial name: NOBLEN BUE81E6, MFR=80 g/10 min) was then fed into the cavity at a rate of 3 g/sec for 1.1 seconds through the runner and the sprue forming the resin passage provided in the first mold, thereby filling the cavity up with the molten propylene-based resin. After 5 seconds from stopping the feed of the molten propylene-based resin, the compression force P2 to the foam substrate was reduced to 0.03 MPa. After cooling was performed until the temperature of the surface of the polypropylene non-crosslinked foam sheet of the foam substrate became 40° C., the molds were opened and then a molded article was taken out. Unnecessary edges were cut off, yielding a molded article in which a rib illustrated in FIG. 5 and FIG. 6 had been joined by welding to a flat plate (the foam substrate). There was no dimple on the resulting molded article's surface corresponding to the portion of the article where the rib was formed and, therefore, the molded article had good appearance.

### Comparative Example 1

The first mold and the second mold were closed until the compression force P0 to the foam substrate would become 0.2 MPa, and vacuum suction at −0.09 MPa was performed through the molding surface of the second mold, thereby shaping the foam substrate. After cooling was performed until the temperature of the surface of the polypropylene non-crosslinked foam sheet of the foam substrate became 80° C., a molten propylene-based resin (polypropylene produced by Sumitomo Chemical Co., Ltd., commercial name: NOBLEN BUE81E6, MFR=80 g/10 min) was then fed into the cavity at a rate of 3 g/sec for 1.1 seconds through the runner and the sprue forming the resin passage provided in the first mold, thereby filling the cavity up with the molten propylene-based resin. While the compression force P0 to the foam substrate at 0.2 MPa, cooling was performed until the temperature of the surface of the polypropylene non-crosslinked foam sheet of the foam substrate became 40° C. Then the molds were opened and a molded article was taken out. Unnecessary edges were cut off, yielding a molded article in which a rib illustrated in FIG. 5 and FIG. 6 had been joined by welding to a flat plate (the foam substrate). A dimple had been formed on the resulting molded article's surface corresponding to the portion of the article where the rib was formed.

### INDUSTRIAL APPLICABILITY

According to the method of the present invention, it is possible to obtain a molded article with good appearance having no dimple on the surface of the molded article opposite to a foam substrate's portion where a functional member has been joined by welding.

1. A method for producing a thermoplastic resin molded article comprising a foam substrate made of a first thermoplastic resin and a functional member made of a second thermoplastic resin which has been joined by welding to the foam substrate so as to project from a surface of the foam substrate, the method comprising the following steps (1) through (6) that are carried out by the use of a molding machine comprising a first mold that has a first molding surface having a recess defining a cavity for forming the functional member therein and that has a resin passage leading to the cavity and a second mold that has a second molding surface and is arranged with the second molding surface facing the first molding surface:
(1) a step of supplying a foam substrate made of the first thermoplastic resin to between the first mold and the second mold;
(2) a step of closing the first mold and the second mold until a force at which the first mold and the second mold compress the foam substrate made of the first thermoplastic resin reaches a predetermined force P1;
(3) a step of supplying the second thermoplastic resin in a molten state into the cavity through the resin passage until the cavity is filled up therewith while maintaining the pressure by which the foam substrate is compressed at P1;
(4) a step of reducing the force by which the foam substrate is compressed from P1 to a predetermined force P2 after stopping supplying the second thermoplastic resin in the molten state:
(5) a step of cooling the second thermoplastic resin to solidify it while compressing the foam substrate at the force P2 by the first and second molds, thereby forming the functional member in the recess and simultaneously forming a thermoplastic resin molded article comprising the functional member and the foam substrate;
(6) a step of opening the molds and taking out the thermoplastic resin molded article.

2. The method according to claim 1, wherein the force P1 is within the range of from 0.1 to 0.5 MPa and the force P2 is within the range of from 0.01 to 0.09 MPa.

3. The method according to claim 2, wherein the P1 and the P2 satisfy the relationship 2≦P1/P2≦30.
